(19) United States
(12) Patent Application Publication
(10) Pub. No.: US 2015/0328873 A1
(43) Pub. Date: Nov. 19, 2015

(54) ELASTIC-PLASTIC FLOOR AND METHOD OF MANUFACTURING THE SAME

(71) Applicant: XIANJU COUNTY DEYI DECORATION MATERIAL CO., LTD., Taizhou (CN)

(72) Inventor: Zhongyou DAI, Taizhou (CN)

(21) Appl. No.: 14/813,149

(22) Filed: Jul. 30, 2015

Related U.S. Application Data
(63) Continuation-in-part of application No. PCT/CN2013/091014, filed on Dec. 31, 2013.

(30) Foreign Application Priority Data
Jan. 30, 2013 (CN) 201310041685.X

(51) Int. Cl. B32B 37/18; B32B 21/04; B32B 38/00; B32B 27/06; B32B 37/12; B32B 37/06

(52) U.S. Cl. CPC B32B 37/182; B32B 37/1284; B32B 37/06; B32B 38/0012; B32B 27/06; B32B 21/04; B32B 2419/04; B32B 2307/554; B32B 2307/51

(57) ABSTRACT

An elastic-plastic floor, including: a surface layer and a sheet layer. The surface layer includes a wear resistant layer and a grained layer. The surface layer and the sheet layer are composited together. The surface layer is wear resistant and is formed by thermally attaching the grained layer to the wear resistant layer. A method of manufacturing an elastic-plastic floor, the method includes: a) shaping the sheet layer in an oven; b) cooling and shaping the sheet layer obtained in a); and c) heating a glue and a glue roller, attaching the surface layer on the sheet layer by coating the glue on the sheet layer after the shaping treatment in b), and rolling to enhance the attachment.

### CROSS-REFERENCE TO RELATED APPLICATIONS

This application is a continuation-in-part of International Patent Application No. PCT/CN2013/091014 with an international filing date of Dec. 31, 2013, designating the United States, now pending, and further claims priority benefits to Chinese Patent Application No. 201310041685.X filed Jan. 30, 2013. The contents of all of the aforementioned applications, including any intervening amendments thereto, are incorporated herein by reference.

### BACKGROUND OF THE INVENTION

1. Field of the Invention

The method of the invention relates to the field of building materials, and more particularly to an elastic-plastic floor and a method of manufacturing the same.

2. Description of the Related Art

A typical PVC floor including a wear resistant layer, a color film layer, a glass fiber layer, and a stone substrate layer is manufactured by the lamination technique. However, bulges and cracks often occur in the tiled PVC floors due to the thermal expansion and contraction. In addition, the manufacturing process of the PVC floor is laborious and energy-consuming, and the patterns fabricated on the floor are unclear and lack the stereo perception.

### SUMMARY OF THE INVENTION

In view of the above-described problems, it is one objective of the invention to provide an elastic-plastic floor and a method of manufacturing the same. The floor of the invention is simple to manufacture, is waterproof, fireproof, does not contain formaldehyde, has good sound insulating properties, has a clear embossed grain pattern, and features high production efficiency, and low energy consumption.

To achieve the above objective, in accordance with one embodiment of the invention, there is provided an elastic-plastic floor. The elastic-plastic floor comprises a surface layer, and a sheet layer. The surface layer comprises a wear resistant layer and a grained layer. The surface layer and the sheet layer are composited together. The surface layer is wear resistant and is formed by thermally attaching the grained layer to the wear resistant layer.

In a class of this embodiment, the sheet layer is made of polyvinyl chloride (PVC) plastic material.

In a class of this embodiment, the sheet layer is a wood sheet.

In accordance with another embodiment of the invention, there is provided a method of manufacturing the elastic-plastic floor. The method comprises: a) shaping the sheet layer in an oven; b) cooling and shaping the sheet layer obtained in a); and c) heating a glue and a glue roller, attaching the surface layer on the sheet layer by coating the glue on the sheet layer after the shaping treatment in b), and rolling to enhance the attachment.

In a class of this embodiment, a temperature of the oven in a) is controlled at a temperature of between 100 and 120° C., and a length of the oven is between 5 and 10 m.

In a class of this embodiment, in b), the sheet layer is cooled by circulating water at an ambient temperature.

In a class of this embodiment, a shaping platform for shaping the sheet layer in b) has a length of 5 m.

In a class of this embodiment, the glue in c) is heated to a temperature of 135° C., and the glue roller is heated to a temperature of between 150 and 160° C.

In a class of this embodiment, a reel of the wear resistant layer and a reel of the grained layer are respectively stretched out and preheated by preheating roller, cured and thermally attached by a heating roller, oppositely rolled by a die roller and a rubber roller to form embossed grains, and cooled by a cooling roller applying water at a temperature of approximately 20° C.

In a class of this embodiment, the die roller is a steel roller.

Advantages of an elastic-plastic floor according to embodiments of the invention are summarized as follows:

The wear resistant layer and the grained layer are thermally attached to form the surface layer by the rolling technique, and the surface layer and the sheet layer are directly attached to prepare the finished product. The product contains three layers. The floor of the invention is simple to manufacture, is waterproof, fireproof, does not contain formaldehyde, has good sound insulating properties, has a clear embossed grain pattern, and features high production efficiency, and low energy consumption.

### DETAILED DESCRIPTION OF THE EMBODIMENTS

For further illustrating the invention, experiments detailing an elastic-plastic floor and a method of manufacturing the same are described below. It should be noted that the following examples are intended to describe and not to limit the invention.

An elastic-plastic floor comprises a surface layer and a sheet layer composited together. The surface layer is wear resistant and is formed by thermally attaching a wear resistant layer and a grained layer together. The sheet layer is a plastic sheet or a wood sheet.

A method of manufacturing the elastic-plastic floor was conducted as follows:

Step a), an oven having a length of between 5 and 10 m, a width of 1.3 m, a height of 1.2 m, and an inner height of 0.3 m was provided, and a temperature of the oven was set to between 100 and 120° C. The sheet layer was conveyed into the oven via a conveying band made of a steel mesh driven by a motor with variable frequency speed regulation. A maximum rotational speed was 50 m per minute. The heating time was adjusted according to a thickness of the sheet layer. A normal production speed of the oven was 30 m per minute. Optionally, the oven adopted electrical heating, and a power of the oven was 25 kw. The sheet layer after the treatment in the oven was thereafter transferred to a shaping platform using cold water.

Step b), the sheet layer was transferred to the shaping platform having a length of 5 m, a width of 1.5 m, and an internal part injected with water at the ambient temperature. A stainless steel mesh was provided for transportation driven by the motor with variable frequency speed regulation. The sheet layer was shaped by cold water and dehydrated by a blower before use. The normal production speed was 30 m per minute so that the thermal tensile formed by extrusion molding was shaped. Plastic is a material having strong thermal sensitivity, thermal expansion and contraction occur after irradiation of the sun or at the low temperature environment, however, the performance stability of the sheet layer after shaping is much excellent than the common PCV plastic floor.

Step c), a glue and a glue roller were heated. The sheet layer after the shaping treatment in b) was coated with the glue to enable the surface layer to be attached thereon, and thereafter the attached surface layer and the sheet layer are rolled for enhancing the attachment.

Specifically, a reel of the surface layer after cutting was placed on a first attaching machine. The glue was heated to the temperature of 135° C., the glue roller was heated to the temperature of between 150 and 160° C., and a scraper was heated to the temperature of 135° C. The sheet layer was coated with the glue by the glue roller and transported to a rolling device, also, the glue could be coated on the wear resistant surface layer. The surface layer was then attached to the sheet layer and rolled by the rolling device. The rolling device had a length of 6 m and a height adjustable according to the thickness of the sheet layer. The sheet layers were continuously fed and it was ensured that no gap existed between the two adjacent sheet layers thereby avoiding the waste of the surface layer. A speed of the first attaching machine was adjusted to between 30 and 40 m per minute, and two sheet layers and two reels of the surface layers were processed synchronously so as to improve the efficiency. Thereafter, a product after the rolling was transferred to a paint roller for coating an ultraviolet (UV) paint on the surface thereof and then processed by a curing machine for curing the paint. The whole procedure was accomplished on an assembly line. The attached floor was cut into strips according to different dimensions, and grooves were fabricated to form desired connectors.

Both the wear resistant layer and the grained layer were plastic materials and were thermally attached together to form the surface layer in c) by rolling in the absence of glue. The reel of the wear resistant layer and the reel of the grained layer were fixed on a thermal attaching machine. Both the wear resistant layer and the grained layer were stretched out and wrapped on a preheating roller where the layers were preheated, and the two layers were cured to a certain degree by a heating roller so as to naturally molten the materials of the two layers into one layer. The newly produced layer was oppositely rolled by a die roller and a rubber roller so as to form embossed grains, in which, the die roller is introduced with cold water for shaping. The produced layer was then cooled by a cooling roller. The cooling roller had a diameter of 50 centimeters, and the water adopted was at the ambient temperature and circulated by a cooling tower for saving the water. After the rough edge was trimmed off, the floor was winded. The whole machine was driven by a speed adjustable motor, and the speed was controlled at between 30 and 60 m per minute, thereby being very simplified.

The temperature of each preheating roller was set according to the thickness of the wear resistant layer.

Herein, the wear resistant surface layer having the thickness of 0.37 mm was taken as an example.

The wear resistant layer having the thickness of 0.3 mm was adopted, and a heating temperature of the preheating roller was controlled at between 160 and 170° C. The grained layer having the thickness of 0.07 mm was adopted, and a heating temperature of the preheating roller was controlled at between 110 and 130° C.

The preheating temperature was adjusted according to the thickness of the product, the oil, and the room temperature during the practical production. The prepared surface layer was then cut into small windings according to the width of the desired floor before use.

When the wear resistant layer and the grained layer having the width of 1.3 m are utilized for production, the production efficiency is more than 4000 square meters per hour, which is 10 folds higher than that of the laminated PVC plastic floor. The whole assembly line only needs three workers, so that 80% of the labor and exceeding 70% of the energy consumption are saved. Moreover, the attachment of the layers is stable, and the extraction rate was small, thereby being applicable to large scale production.

The thermal attachment is applicable for plastic materials and is based on working principle that the interfaces of the plastic materials are interactively dissolved when being heated, which is very different from the principle of the common wood composite floor based on the high temperature and high pressure.

The embossed grains of the surface layer are formed using the rolling technique. The thickness of the wear resistant layer is generally between 0.3 and 0.5 mm, and the thickness of the strained layer is 0.07 mm. The wear resistant layer and the strained layer are thin and prone to be softened by heating during the thermal attachment. The formation of the embossed grains is realized by opposite rolling by die roller and the rubber roller for one time. The final product has real stereo perception and the die is simple. In contrast, the common PVC plastic floor manufactured by the lamination technique results in a common thickness of between 4 and 5 mm, thus it cannot bear a relatively high temperature on a pressing machine, thereby being insufficiently softened. In addition, the common PVC plastic floor contains multiple layers, the lamination effect is not good, the die is in the sheet form, the embossed grain pattern is uneven and unclear and lacks the stereo perception.

The elastic-plastic floor comprising the wear resistant surface layer and the PVC foam sheet are advantageous in the following respects:

1. Light specific gravity. The specific gravity of the finished product of the invention is generally 0.8-1.0. The elastic-plastic floor of the invention has a light specific gravity that is negligible when imposing on a building and saves approximately between 40% and 50% cost in transportation compared with the common PVC floor. Specific gravities of the existing plastic PVC foamed floor and the plastic floor are 1.7-2.0, and 2.0, respectively.

2. Stable physical performance. The PVC foamed sheet is shaped at the high temperature in the oven. It has been proved by the physical performance test that after keeping the PVC foamed sheet in the oven at the temperature of 80° C. for 12 hrs, the shrinkage is smaller than 0.1%, and no shrinkage occur in the transverse direction. Thus, the dimension of the PVC foamed sheet of the invention is much stable than that of the PVC plastic floor.

3. Low cost. The elastic-plastic floor can be produced in batches on the assembly line, and the floor of the invention has simple structure and does not contain the glass fiber layer and the PVC substrate layer compared with the current PVC floor, thereby having much lower cost than the current PVC floor.

4. Colorful grain patterns. Wood-like, rock-like, steel-like, carpet-like, etc. grain patterns with high color simulation can be can be fabricated on the grained layer according to the requirements.

5. Common features of the plastic floor, such as fireproothess, waterproofness, corrosion resistance, mothproofness, and no formaldehyde.

The elastic-plastic floor also features high efficiency and low energy consumption during the production, strong stereo perception of embossed grains on the surface, high product quality with safe use, no formaldehyde, and stable performance.

The surface layer can also adopt the PVC plastic or other plastic materials.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A floor, comprising:
a) a surface layer, the surface layer comprising a wear resistant layer and a grained layer; and
b) a sheet layer;
wherein
the surface layer and the sheet layer are composited together; and the surface layer is wear resistant and is formed by thermally attaching the grained layer to the wear resistant layer.

2. The floor of claim 1, wherein the sheet layer is made of polyvinyl chloride (PVC) plastic material.

3. The floor of claim 1, wherein the sheet layer is a wood sheet.

4. A method of manufacturing the floor of claim 1, the method comprising:
a) shaping the sheet layer in an oven;
b) cooling and shaping the sheet layer obtained in a); and
c) heating a glue and a glue roller, attaching the surface layer on the sheet layer by coating the glue on the sheet layer after the shaping treatment in b), and rolling to enhance the attachment.

5. The method of claim 4, wherein a temperature of the oven in a) is controlled at a temperature of between 100 and 120° C., and a length of the oven is between 5 and 10 m.

6. The method of claim 4, wherein in b), the sheet layer is cooled by circulating water at an ambient temperature.

7. The method of claim 4, wherein a shaping platform for shaping the sheet layer in b) has a length of 5 m.

8. The method of claim 4, wherein the glue in c) is heated to a temperature of 135° C., and the glue roller is heated to a temperature of between 150 and 160° C.

9. The method of claim 4, wherein a reel of the wear resistant layer and a reel of the grained layer are respectively stretched out and preheated by preheating roller, cured and thermally attached by a heating roller, oppositely rolled by a die roller and a rubber roller to form embossed grains, and cooled by a cooling roller applying water at a temperature of approximately 20° C.

10. The method of claim 9, wherein the die roller is a steel roller.
